(19) United States
(12) Patent Application Publication
(10) Pub. No.: US 2024/0072451 A1
(43) Pub. Date: Feb. 29, 2024

(54) RIS WITH LC

(71) Applicant: Korea Electronics Technology Institute, Seongnam-si (KR)

(72) Inventors: Seung Goo NAM, Suwon-si (KR); Se Hwan CHOI, Seongnam-si (KR)

(21) Appl. No.: 18/135,352

(22) Filed: Apr. 17, 2023

(30) Foreign Application Priority Data
Aug. 29, 2022 (KR) 10-2022-0108042

(51) Int. Cl. H01Q 15/00; H01Q 3/44

(52) U.S. Cl. CPC H01Q 15/0013; H01Q 3/44

(57) ABSTRACT

There is provided an RIS with LC. According to an embodiment, an RIS includes: a plurality of RIS elements; and an RIS controller configured to control the RIS elements to steer an RF signal entering, and the RIS element includes: a first substrate; a second substrate; an antenna disposed between the first substrate and the second substrate; a ground disposed between the first substrate and the second substrate; and an LC phase shifter disposed between the antenna and the ground to change a phase of the RF signal entering. Accordingly, a phase shifter for changing a phase of an RF signal entering is implemented by using LC, so that an RIS may be implemented on a transparent window without obstructing light or a field of vision, and also, an outdoor reflect mode and an indoor transmit mode may be supported by one RIS.

### CROSS-REFERENCE TO RELATED APPLICATION(S) AND CLAIM OF PRIORITY

This application is based on and claims priority under 35 U.S.C. § 119 to Korean Patent Application No. 10-2022-0108042, filed on Aug. 29, 2022, in the Korean Intellectual Property Office, the disclosure of which is herein incorporated by reference in its entirety.

### BACKGROUND

### Field

The disclosure relates to a mobile communication technology, and more particularly, to a reconfigurable intelligent surface (RIS) for improving a coverage of a radio frequency (RF) signal in 5G mobile communication.

### Description of Related Art

Millimeter wave used in 5G mobile communication may have a problem that it causes many shadow zones due to strong straightness of radio waves. To solve this problem, an RIS which functions as a beam reflection plate to expand a coverage and performs beam steering has been developed. As shown in FIGS. 1 to 3, the RIS may enhance a channel link between a base station and a device and may also enhance a connection state between devices.

In addition, as shown in FIG. 4, the RIS may be installed on an inside wall surface to reflect beams entering through a window to an indoor device. However, in a process of reflecting beams entering through a window through an RIS installed on a wall surface, a path loss may occur. In addition, there may be inconvenience that an obstacle (a computer, a desk, other furniture, etc.) cannot be installed in front of the wall surface on which the RIS is installed.

Furthermore, the use of an existing RIS may be limited to outdoor use (FIGS. 1 to 3) or indoor use (FIG. 4). That is, an RIS for outdoor use may not be used for indoor use.

The RIS may be configured with a plurality of RIS elements arranged in a grid pattern. FIG. 5 illustrates a structure of an RIS element. As shown in FIG. 5, the RIS element should have a phase shifter inserted between an antenna and a ground, and may require a phase shift pattern, a diode, and a capacitor to implement the phase shifter. Accordingly, the RIS element may have a large volume and a complicated structure, and may make it difficult to achieve mass production and stability.

### SUMMARY

The disclosure has been developed in order to solve the above-described problems, and an object of the disclosure is to provide an RIS which can be implemented on a transparent window by using liquid crystal (LC) and can selectively operate while switching between an outdoor reflect mode and an indoor transmit mode.

According to an embodiment of the disclosure to achieve the above-described object, there is provided an RIS including: a plurality of RIS elements; and an RIS controller configured to control the RIS elements to steer an RF signal entering, wherein the RIS element includes: a first substrate; a second substrate; an antenna disposed between the first substrate and the second substrate; a ground disposed between the first substrate and the second substrate; and an LC phase shifter disposed between the antenna and the ground to change a phase of the RF signal entering.

The RIS controller may control phase shifts of RF signals by the LC phase shifters of the RIS elements.

The RIS controller may control the phase shifts of the RF signals by the LC phase shifters by controlling bias voltages applied to both ends of each of the LC phase shifters.

The RIS controller may control the RIS elements to transmit the RF signals entering, respectively. The RIS controller may control the RIS elements to reflect the RF signals entering, respectively.

The first substrate and the second substrate may be substrates of a transparent material. A window may be formed by the first substrate and the second substrate.

Transmission of the RF signal may be performed from an outside of a building in which a window is installed to an inside. Reflection of the RF signal may be performed from an outside of a building in which a window is installed to an outside.

According to another embodiment of the disclosure, there is provided an RF signal steering method including: receiving an RF signal entering; and steering the RF signal by controlling a plurality of RIS elements, and outputting the RF signal, wherein the RIS element includes: a first substrate; a second substrate; an antenna disposed between the first substrate and the second substrate; a ground disposed between the first substrate and the second substrate; and an LC phase shifter disposed between the antenna and the ground to change a phase of the RF signal entering.

According to still another embodiment of the disclosure, there is provided an RIS element including: a first substrate; a second substrate; an antenna disposed between the first substrate and the second substrate; a ground disposed between the first substrate and the second substrate; and an LC phase shifter disposed between the antenna and the ground to change a phase of an RF signal entering.

According to yet another embodiment of the disclosure, there is provided an RF signal phase changing method including: receiving, by an RIS element constituting an RIS, an RF signal; changing, by the RIS element, a phase of the RF signal; and outputting, by the RIS element, the RF signal the phase of which is changed, wherein the RIS element includes: a first substrate; a second substrate; an antenna disposed between the first substrate and the second substrate; a ground disposed between the first substrate and the second substrate; and an LC phase shifter disposed between the antenna and the ground to change a phase of the RF signal entering.

According to embodiments of the disclosure as described above, a phase shifter for changing a phase of an RF signal entering is implemented by using LC, so that an RIS may be implemented on a transparent window without obstructing light or a field of vision, and also, an outdoor reflect mode and an indoor transmit mode may be supported by one RIS.

According to embodiments of the disclosure, LC is used as a phase shifter, so that a volume and complexity of an RIS element may be reduced, and difficulty in manufacturing may be reduced, and mass production and stability may be achieved.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating an example of use of an RIS in an outdoor environment;

FIG. 2 is a view illustrating an example of use of an RIS in an outdoor environment;

FIG. 3 is a view illustrating an example of use of an RIS in an outdoor environment;

FIG. 4 is a view illustrating an example of use of an RIS in an indoor environment;

FIG. 5 is a view illustrating a structure of a related-art RIS element;

FIG. 6 is a view illustrating a structure of an RIS element according to an embodiment of the disclosure;

FIG. 7 is a view illustrating a structure of an RIS according to another embodiment of the disclosure;

FIG. 8 is a view illustrating a structure of an RIS element constituting the RIS of FIG. 7;

FIG. 9 is a view illustrating a structure of an RIS element constituting the RIS of FIG. 7;

FIG. 10 is a cross-sectional view illustrating a via structure of the RIS element illustrated in FIG. 9;

FIG. 11 is a view illustrating a result of simulating the RIS element according to an embodiment of the disclosure;

FIG. 12 is a view illustrating an example of beam steering by the RIS according to an embodiment of the disclosure;

FIG. 13 is a view illustrating a reflect mode of the RIS according to an embodiment of the disclosure; and

FIG. 14 is a view illustrating a transmit mode of the RIS according to an embodiment of the disclosure.

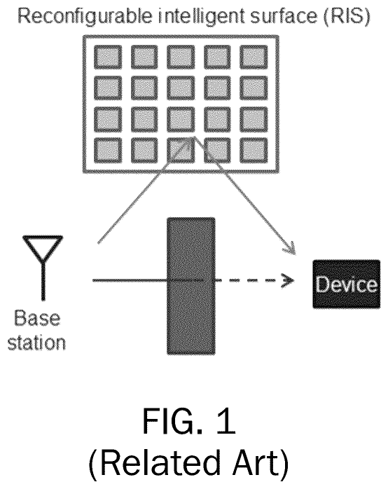

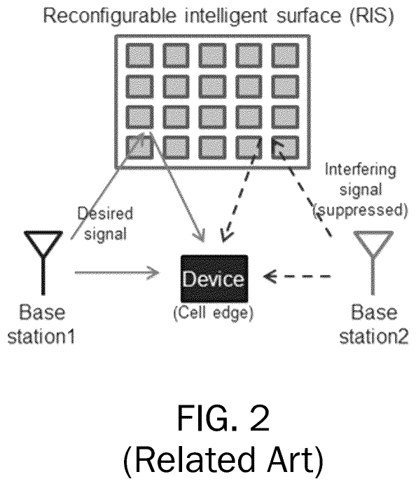

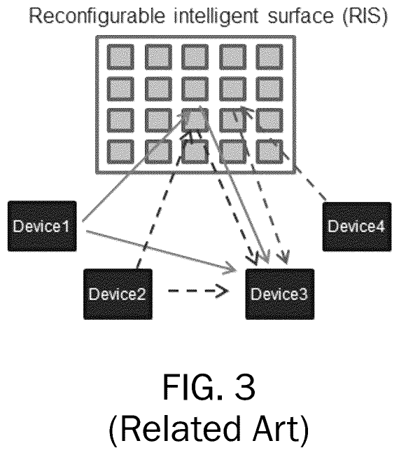

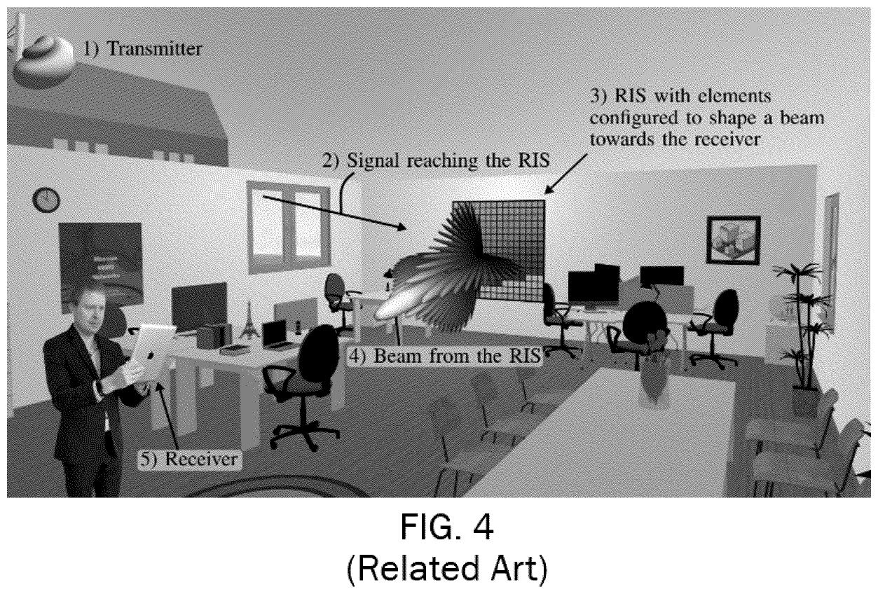

### DETAILED DESCRIPTION

Hereinafter, the disclosure will be described in more detail with reference to the accompanying drawings.

Embodiments of the disclosure propose an RIS element and an RIS using the same.

The RIS element according to an embodiment has a phase shifter implemented by LC, such that an RIS can be implemented on a transparent window without obstructing light or a field of vision, and a volume of the RIS element can be reduced and a structure can be simplified.

In addition, the RIS may be selectively operated in a reflect mode in which the RIS on a window reflects an RF signal entering from an outside to an outside, and a transmit mode in which the RIS transmits an RF signal entering from an outside to an inside.

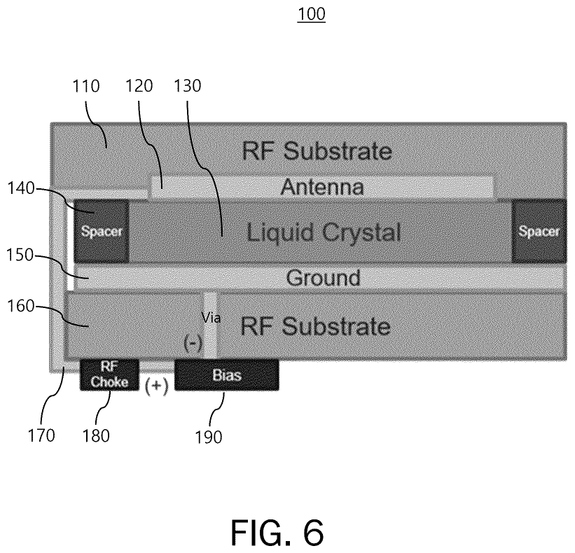

FIG. 6 is a view illustrating a structure of an RIS element according to an embodiment. The RIS element 100 according to an embodiment may include an upper substrate 110, an antenna 120, LC 130, a spacer 140, a ground 150, a lower substrate 160, a via 170, an RF choke 180, and a bias 190.

As shown in FIG. 6, the antenna 120 may be positioned on a lower portion of the upper substrate 110, and the ground 150 may be positioned on an upper portion of the lower substrate 160. The LC 130 may be inserted into a space between the antenna 120 and the ground 150.

The spacer 140 may be positioned between the upper substrate 110 and the ground 150 to form a space. According to patterns of the antenna 120 and the ground 150, an upper portion of the spacer 140 may be in contact with the antenna 120 rather than the upper substrate 110, and a lower portion of the spacer 140 may be in contact with the lower substrate 160 rather than the ground 150.

The LC 130 functions as a phase shifter to change a phase of an RF signal entering through the antenna 120. A bias voltage may be applied to both ends of the LC 130 through the antenna 120 and the ground 150. However, the bias voltage may be directly applied to both ends of the LC 130. The RF choke 180 may block only a specific frequency component from the bias voltage.

The LC 130 may have its permittivity changed according to an applied bias voltage to change a phase of an RF signal entering. A phase shift of the RF signal by the LC 130 may be determined according to a bias voltage applied to the LC 130. That is, the phase shift of the RF signal may be adjusted by adjusting the bias voltage applied to the LC 130.

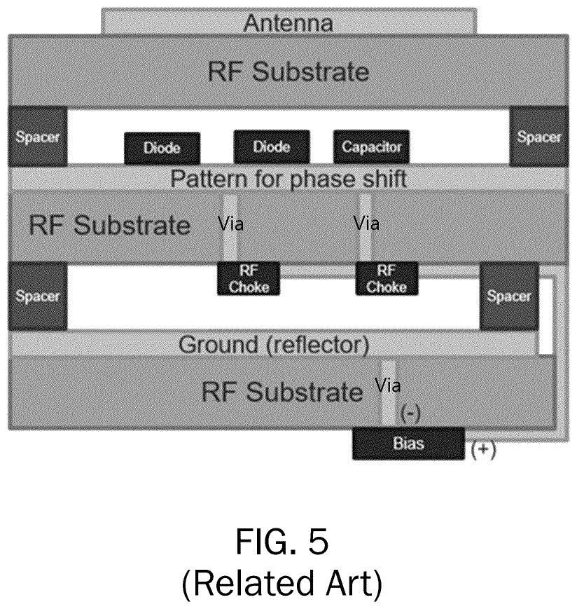

The RIS element according to an embodiment differs from a related-art RIS element (FIG. 5) in that the RIS element does not require a pattern, a capacitor, a diode, etc. for a phase shift of an RF signal.

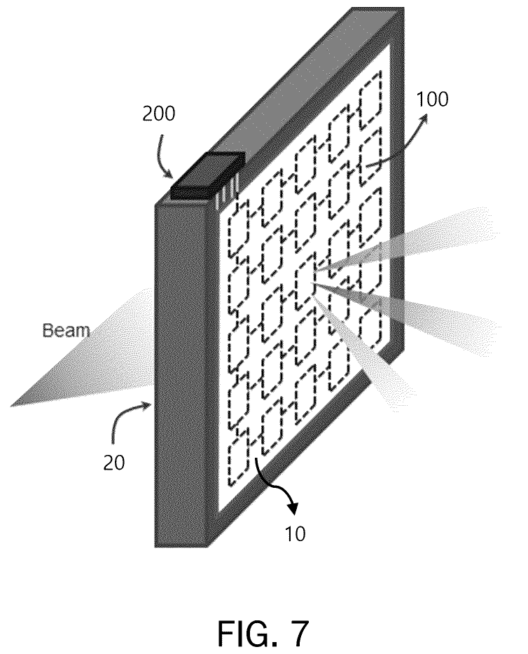

An RIS using the RIS element according to an embodiment will be described in detail with reference to FIG. 7. FIG. 7 is a view illustrating a structure of an RIS according to another embodiment of the disclosure.

As shown in FIG. 7, the RIS according to an embodiment may include a plurality of RIS elements 100 and an RIS controller 200. The RIS according to an embodiment may be implemented on a transparent window 10 mounted in a window frame 20.

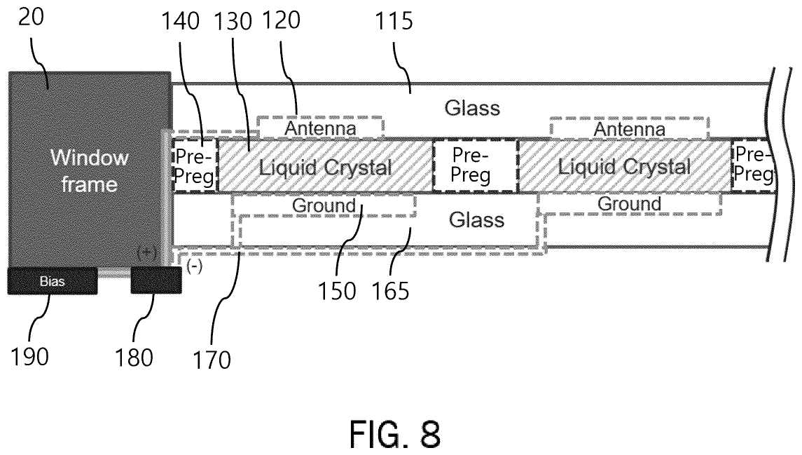

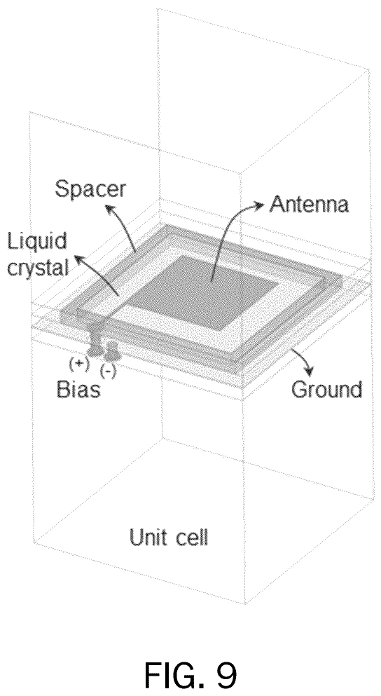

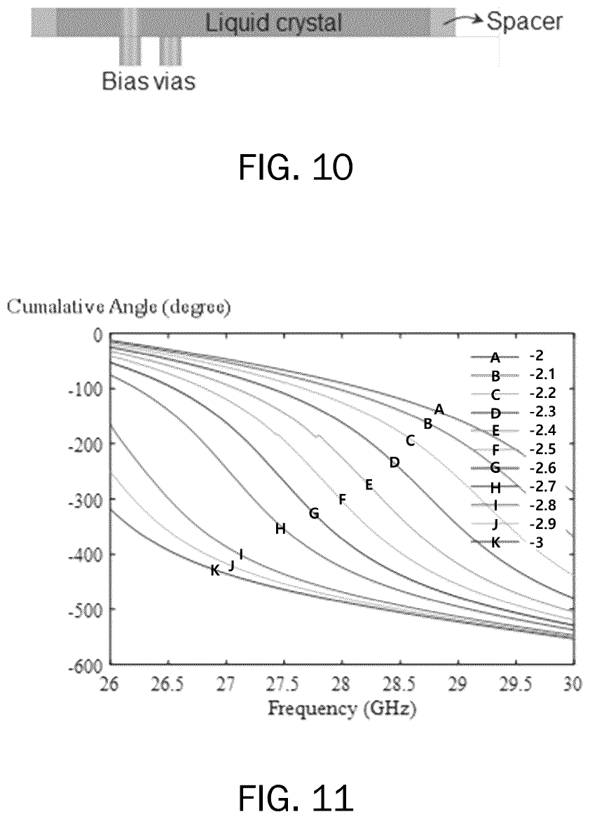

To achieve this, an upper substrate and a lower substrate of the RIS element 100 may be implemented by using substrates 115, 165 of transparent glass as shown in FIG. 8. FIG. 9 is a perspective view illustrating a structure of the RIS element in which substrates of glass are applied to an upper portion and a lower portion. FIG. 10 is a cross-sectional view illustrating a via structure of the RIS element.

The RIS controller 200 controls phase shifts by the RIS elements 100, respectively, and eventually steers an RF signal entering through the RIS. The phase shift of the RF signal by the RIS element 100 may be dependent on a change in permittivity of the LC 130.

FIG. 11 illustrates a result of simulating a phase shift of an RF signal, which is dependent on permittivity of the LC 130 inserted into the RIS element 100, according to a frequency. The result of simulating shows that, when permittivity changes from 2 to 3, a phase shift of 360 degrees or more occurs.

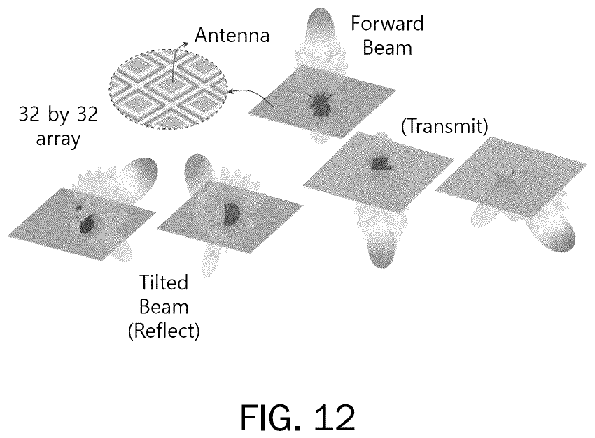

This shows that the RIS controller 200 is able to steer an RF signal in any desired direction by controlling a bias voltage applied to LCs 140 of the RIS elements 100. FIG. 12 illustrates beam steering performed by an RIS in which RIS elements 100 are arranged by 32×32. As shown in FIG. 12, an RF signal may be steered in a direction of reflection from the RIS, and also, may be steered in a direction of transmitting through the RIS.

Since the RIS elements 100 of the RIS according to an embodiment are implemented on the transparent window 10, the RIS elements 100 are able to steer beams in a desired direction while transmitting an RF signal entering from an outside of the window 10 to an inside, so that an indoor coverage can be greatly enhanced.

Accordingly, the RIS according to an embodiment may be operated not only in a reflect mode but also in a transmit mode, and may steer an RF signal in a desired direction in the transmit mode as well as in the reflect mode.

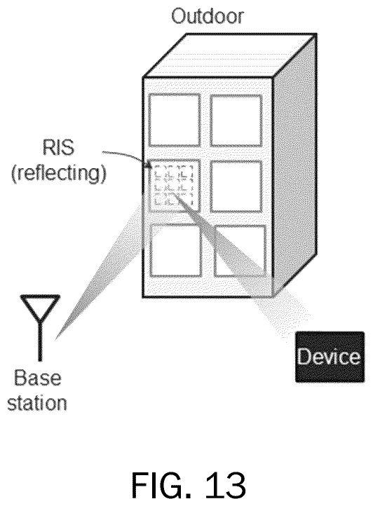

FIG. 13 illustrates a case in which the RIS according to an embodiment is operated in the reflect mode. As shown in FIG. 13, the reflect mode is a mode in which an RIS implemented on a window of a building reflects a signal of a base station positioned outside to a device positioned outside. In this mode, the RIS may reflect a signal of a device to another device although this is not illustrated.

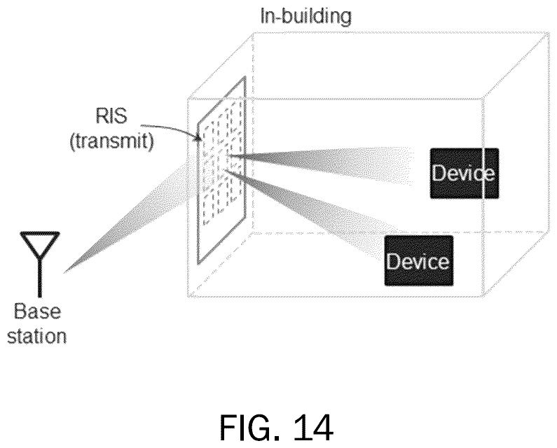

FIG. 14 illustrates a case in which the RIS according to an embodiment is operated in the transmit mode. As shown in FIG. 14, the transmit mode is a mode in which an RIS implemented on a window of a building allows a signal of a base station positioned outside to pass therethrough and transmits the signal to devices positioned inside.

According to an embodiment, the operations modes of the RIS may be selectively performed by the RIS controller 200 controlling phase shifts of RF signals by the RIS elements 100.

Up to now, an RIS element in which LC is applied as a phase shifter and an RIS which is implemented on a transparent window by using the same have been described in detail with reference to preferred embodiments.

In an embodiment of the disclosure, the phase shifter of the RIS element is implemented by LC, so that the RIS may be implemented on a transparent window without obstructing light or a field of vision, and also, may be selectively operated in a reflect mode to increase an outdoor coverage or a transmit mode to increase an indoor coverage.

In particular, since an RF signal transmitted through a window can be directly steered toward a desired position inside, rather than being reflected by a wall, the RIS according to an embodiment may have an advantage that a path loss is small compared to an existing structure.

In addition, a volume and complexity of an RIS element may be reduced, and difficulty in manufacturing may be reduced, and mass production and stability may be achieved.

The technical concept of the present disclosure may be applied to a computer-readable recording medium which records a computer program for performing the functions of the apparatus and the method according to the present embodiments. In addition, the technical idea according to various embodiments of the present disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. An RIS comprising:
a plurality of RIS elements; and
an RIS controller configured to control the RIS elements to steer an RF signal entering,
wherein the RIS element comprises:
a first substrate;
a second substrate;
an antenna disposed between the first substrate and the second substrate;
a ground disposed between the first substrate and the second substrate; and
an LC phase shifter disposed between the antenna and the ground to change a phase of the RF signal entering.

2. The RIS of claim 1, wherein the RIS controller is configured to control phase shifts of RF signals by the LC phase shifters of the RIS elements.

3. The RIS of claim 2, wherein the RIS controller is configured to control the phase shifts of the RF signals by the LC phase shifters by controlling bias voltages applied to both ends of each of the LC phase shifters.

4. The RIS of claim 2, wherein the RIS controller is configured to control the RIS elements to transmit the RF signals entering, respectively.

5. The RIS of claim 4, wherein the RIS controller is configured to control the RIS elements to reflect the RF signals entering, respectively.

6. The RIS of claim 5, wherein the first substrate and the second substrate are substrates of a transparent material.

7. The RIS of claim 6, wherein a window is formed by the first substrate and the second substrate.

8. The RIS of claim 7, wherein transmission of the RF signal is performed from an outside of a building in which a window is installed to an inside.

9. The RIS of claim 7, wherein reflection of the RF signal is performed from an outside of a building in which a window is installed to an outside.

10. An RF signal steering method comprising:
receiving an RF signal entering; and
steering the RF signal by controlling a plurality of RIS elements, and outputting the RF signal,
wherein the RIS element comprises:
a first substrate;
a second substrate;
an antenna disposed between the first substrate and the second substrate;
a ground disposed between the first substrate and the second substrate; and
an LC phase shifter disposed between the antenna and the ground to change a phase of the RF signal entering.

11. An RIS element comprising:
a first substrate;
a second substrate;
an antenna disposed between the first substrate and the second substrate;
a ground disposed between the first substrate and the second substrate; and
an LC phase shifter disposed between the antenna and the ground to change a phase of an RF signal entering.
